(19) United States
(12) Patent Application Publication
(10) Pub. No.: US 2017/0219014 A1
(43) Pub. Date: Aug. 3, 2017

(54) Soft Coating for Splined Connections Between Motor Shafts of Submersible Pump Assembly

(71) Applicant: Baker Hughes Incorporated, Houston, TX (US)

(72) Inventors: Scott C. Strattan, Broken Arrow, OK (US); Yong Li, Owasso, OK (US)

(73) Assignee: Baker Hughes Incorporated, Houston, TX (US)

(21) Appl. No.: 15/407,451

(22) Filed: Jan. 17, 2017

Related U.S. Application Data
(60) Provisional application No. 62/288,233, filed on Jan. 28, 2016.

(51) Int. Cl. F16D 3/06; E21B 17/046

(52) U.S. Cl. CPC F16D 3/06; E21B 17/046; E21B 43/128

(57) ABSTRACT

An electrical submersible pump assembly has modules, including a pump, a seal section and a motor. A rotatable first drive shaft in a first one of the modules has a splined end that mates with a splined end of a rotatable second drive shaft in a second one of the modules. An external set of splines is on mating ends of the first drive shaft and the second drive shaft. A coupling has an internal set of splines that mesh with the external set to rotationally couple the first and second drive shafts to each other. A polymer coating is selectively bonded on one of the sets and in sliding engagement with the other set. The coating is a solid polymer material having a lower coefficient of friction than steel alloys of the internal set and the external set.

### CROSS REFERENCE TO RELATED APPLICATION

This application claims priority to provisional application Ser. No. 62/288,233, filed Jan. 28, 2016.

### FIELD OF THE DISCLOSURE

This disclosure relates in general to electrical submersible well pump assemblies and in particular to splined connections that connect shafts of the modules of the assembly, the splined connections having a coating of a soft material on the splines.

### BACKGROUND

Electrical submersible pump assemblies (“ESP”) are often used in hydrocarbon producing wells to pump well fluid to the surface. A typical ESP has a number of modules, each module having a drive shaft. The modules include an electrical motor, a seal section, and a pump. Connectors on ends of the modules connect the modules together. The drive shafts in the modules have ends that mate with ends in adjacent modules. The ends are externally splined, and a coupling with internal splines meshes with the external splines to transmit torque from one drive shaft to another.

ESPs have a length much greater than the diameter. The drive shafts of the different modules can be slightly out of alignment. Vibration is a common problem caused by misalignment of the drive shafts.

Also, thermal growths of the drive shafts during operation will cause axial sliding motion between the splined ends and the coupling. The friction between the splined ends and the couplings may overload a bottom thrust bearing and cause high compression loading on the drive shaft.

### SUMMARY

An apparatus for pumping well fluid from a well comprises an electrical submersible pump assembly (“ESP”) having a longitudinal axis and a plurality of modules, including a pump, a seal section and a motor. A rotatable first drive shaft is in a first one of the modules, the first drive shaft being formed of a steel alloy. A rotatable second drive shaft is in a second one of the modules, the second drive shaft being formed of a steel alloy. An external set of splines is on end portions of the first drive shaft and the second drive shaft. A coupling formed of a steel alloy has an internal set of splines that mesh with the external set to rotationally couple the first and second drive shafts to each other. A coating is selectively on either the internal set or on the external set. The coating is of a softer material than the materials of the internal set and the external set.

In the embodiment described, the coating is a polymer. The polymer may be selected from the group consisting of polytetrafluoroethylene and polyimide.

The coating may have a thickness in the range from 0.002 to 0.014 inch. In one embodiment, the coating is only on the internal set, and the external set is free of any coatings.

The coating is a solid material. It has a lower coefficient of friction than the steel alloys of the first and second drive shafts and the coupling. Also, the coating has a lower elastic modulus than the steel alloys of the first and second drive shafts and the coupling.

### BRIEF DESCRIPTION OF THE DRAWINGS

FIG. 1 is a side view of submersible well pump assembly having splined connections between the shafts of the modules of the pump assembly in accordance with this disclosure.

FIG. 2 is an enlarged exploded side view, partially sectioned, of the one of the splined connections of the pump assembly of FIG. 1.

FIG. 3 is an enlarged end view of a coupling of the splined connection of FIG. 2.

FIG. 4 is a further enlarged transverse sectional view of part of the coupling of FIG. 3.

FIG. 5 is an end view of the coupling of FIG. 3, also showing one of the drive shaft ends installed within.

While the invention will be described in connection with the preferred embodiments, it will be understood that it is not intended to limit the invention to that embodiment. On the contrary, it is intended to cover all alternatives, modifications, and equivalents, as may be included within the spirit and scope of the invention as defined by the appended claims.

### DETAILED DESCRIPTION OF THE DISCLOSURE

The method and system of the present disclosure will now be described more fully hereinafter with reference to the accompanying drawings in which embodiments are shown. The method and system of the present disclosure may be in many different forms and should not be construed as limited to the illustrated embodiments set forth herein; rather, these embodiments are provided so that this disclosure will be thorough and complete, and will fully convey its scope to those skilled in the art. Like numbers refer to like elements throughout. In an embodiment, usage of the term “about” includes +/−5% of the cited magnitude. In an embodiment, usage of the term “substantially” includes +/−5% of the cited magnitude.

It is to be further understood that the scope of the present disclosure is not limited to the exact details of construction, operation, exact materials, or embodiments shown and described, as modifications and equivalents will be apparent to one skilled in the art. In the drawings and specification, there have been disclosed illustrative embodiments and, although specific terms are employed, they are used in a generic and descriptive sense only and not for the purpose of limitation.

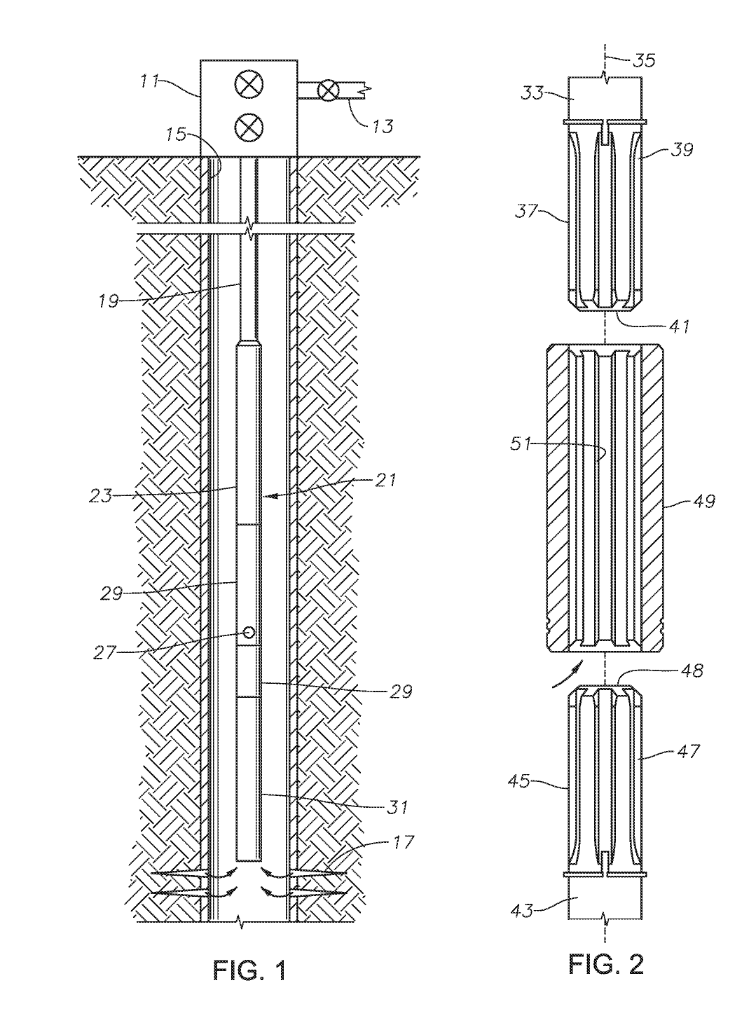

FIG. 1 schematically illustrates a wellhead 11 at the upper end of a well. A flowline 13 joins wellhead 11 to convey well fluid from the well. A string of casing 15 cemented in the well has perforations 17 or other openings to receive well fluid from adjacent earth formations. Wellhead 11 supports a string of production tubing 19 extending into casing 15.

An electrical submersible pump assembly 21 (ESP) secures to a lower end of production tubing 19. ESP 21 may be installed in a well in a variety of ways other than the way shown. ESP 21 includes a pump 23, which is normally a rotary pump such as a centrifugal pump having a large number of stages, each stage having a rotatable impeller and a nonrotating diffuser. Alternately, other types of pumps, such as a progressive cavity pump, may be used.

In this example, an optional gas separator 25 secures to the lower end of pump 23. Gas separator 25 has rotating components that separate lighter or gaseous portions of the well fluid from heavier or liquid portions of the well fluid. Gas separator 25 has an intake 27 for receiving well fluid flowing through perforations 17. If gas separator 25 is not used, intake 27 would be at the lower end of pump 23.

A seal section 29 secures to the lower end of gas separator 25 in this example. A motor 31, typically a three-phase electrical motor, secures to the lower end of seal section 29. A dielectric lubricant fills motor 31, and seal section 29 seals the lubricant within motor 31. Seal section 29 may have pressure equalizing features, such as a bag or bellows, for equalizing the internal lubricant pressure with the hydrostatic pressure surrounding motor 31. Alternately, a pressure equalizer could be mounted to the lower end of motor 31.

Pump 23, gas separator 25, seal section 29 and motor 31 comprise modules that are normally brought to a well site disconnected from each other. Connectors made up at the well site secure the various modules into ESP 21. The connectors may be bolted connections or employ rotatable sleeves with threads.

Each module 23, 25, 29 and 31 has a rotatable drive shaft. Referring to FIG. 2, a first draft shaft 33 is located in one of the modules 23, 25, 29 or 31, which may be considered to be a first module. First drive shaft 33 extends along a longitudinal axis 35 and has a splined end 37. External splines 39 extend around the circumference of splined end 37 parallel with axis 35. External splines 39 extend to a bottom end 41 of first drive shaft 33. External splines 39 are identical to each other and spaced evenly apart.

A second drive shaft 43 is located in a second module that is to be connected to the first module. Second drive shaft 43 has a splined end 45 with external splines 47. External splines 47 extend around the circumference of splined end 45 parallel with axis 35 and terminate at a top end 48 of second drive shaft 43. External splines 39 and 47 may be considered to make up a set of external splines.

A sleeve or coupling 49 joins first splined end 37 with second splined end 45 to transmit torque between drive shafts 33, 43. Coupling 49 has a bore with a set of internal splines 51 extending around the side wall of the bore. Internal splines 51 are configured to mesh with external splines 39, 47 as coupling 49 slides over splined ends 37, 45. When adjacent modules are made up, first and second splined ends 37, 45 slide into coupling 49 and mesh with internal splines 51. Bottom end 41 may abut top end 48 when fully made up in order to transmit an axial compressive load or down thrust caused by pump 23 (FIG. 1). Devices (not shown) may be present that releasably connect bottom end 41 to top end 48 to transmit axial tension or up thrust.

In this example, internal splines 51 extend continuously from the top to the bottom of coupling 49. Alternately, coupling 49 could be in two pieces, with the internal splines 51 in the upper half mating with external splines 39, and the internal splines 51 in the lower half mating with external splines 47. The circumscribed diameter of first splined end 37 could differ from the circumscribed diameter of second splined end 45, in which case the internal splines 51 in the upper half of coupling 49 would have a different circumscribed inner diameter than the internal splines 51 in the lower half. First drive shaft 33, second drive shaft 43 and coupling 49 are preferably formed of steel alloys which may be the same or differ.

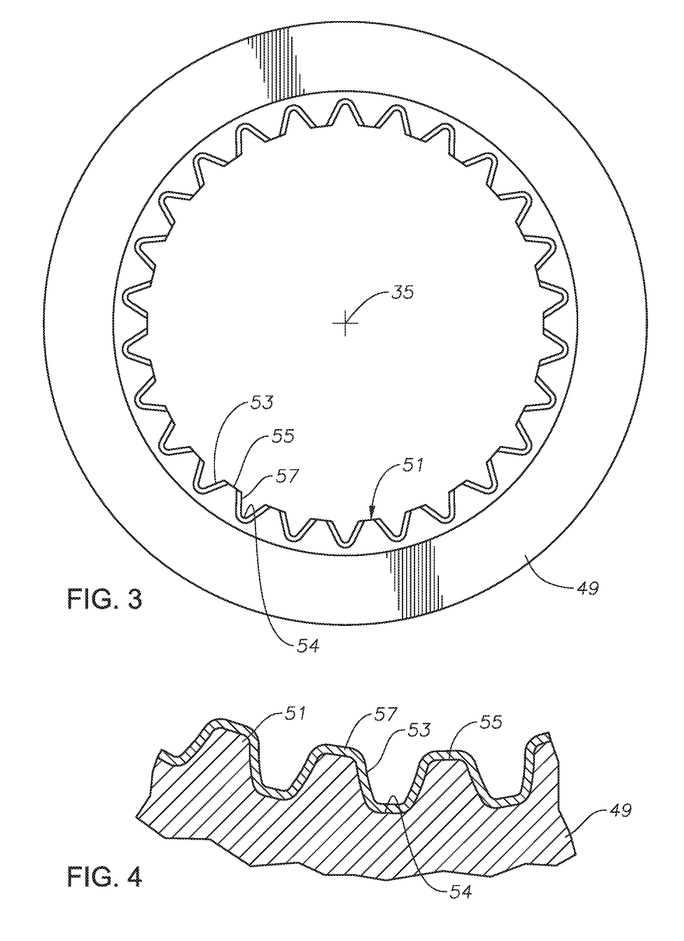

Referring to FIGS. 3 and 4, internal splines 51 may have a variety of cross-sectional shapes. In this example, each internal spline 51 has flanks 53 that converge to a flat or slightly rounded crest 55. A rounded valley 54 separates each internal spline 51 from those on opposite sides.

A coating 57 is bonded to internal splines 51 in this example. Alternately, coating 47 could be applied to the set of external splines 39, 47. Coating 57 at least covers flanks 53, and in this example, also covers valleys 54. Coating 57 optionally may cover crests 55, as illustrated in FIG. 4, or not cover crests 55, as illustrated in FIG. 3. In this embodiment, coating 57 is only on either internal splines 51 or on external splines 39, 47. The outer surface of coating 57 is in contacting engagement with the steel alloy surfaces of external splines 39, 47.

Coating 57 is solid layer that is of a softer material than the steel alloy material of coupling 49 as well as splined ends 37, 45 (FIG. 2). Coating 57 has a lower coefficient of friction than the steel alloy material of coupling 49 and splined ends 37, 45 for reducing axial friction between internal splines 51 and external splines 39, 47. Axial friction can occur due to thermal growth of drive shafts 33, 43 during operation, causing coating 57 to slidingly engage the steel alloy surfaces of external splines 39, 47. Coating 57 has a smooth finish that engages external splines 39, 47. The machined steel alloy surface of internal splines 51, particularly at flanks 53, should not have protrusions with heights greater than the thickness of coating 57 so that the outer surface of coating 57 has a low coefficient of friction.

Coating 57 also has a lower elastic modulus than the steel alloy material of coupling 49 and splined ends 37, 45 to better handle misalignment of drive shafts 33, 43, which can cause vibration. Coating 57 can undergo compressive elastic deformation during operation due to axial misalignment of drives shafts 33, 43. Suitable materials for coating 57 are polymers such as polytetrafluoroethylene (PTFE) or polyimide and the like. The thickness of coating 57 may vary, for example from about 0.002 to 0.014 inch.

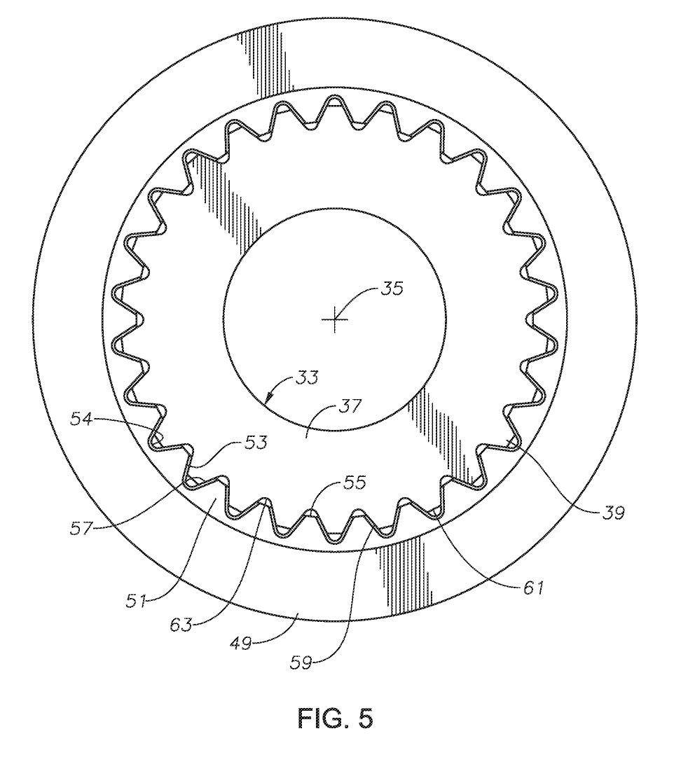

FIG. 5 illustrates first drive shaft splined end 37 installed within coupling 49. Second draft shaft splined end 45 would appear the same as in FIG. 5. External splines 39 of splined end 37 have flanks 59 that mate with internal spline flanks 53 to transmit torque. Flanks 59 of external splines 39 converge to a flat or slightly rounded crest 61. Rounded valleys 63 separate adjacent external splines 39. A coating such as coating 57 is not applied to external splines 39 in this embodiment. Alternately, a coating such as coating 57 could be applied to external splines 39 with internal splines 51 left free of such a coating.

While intermeshing in this embodiment as shown in FIG. 5, crests 61 of external splines 39 do not touch internal spline valleys 54. Similarly, crests 55 of internal splines 51 do not touch external spline valleys 63. External spline flanks 59 engage the coatings 57 on internal spline flanks 53. The machined surface finish of external spline flanks 59 should be smooth; for example, the surfaces of external spline flanks 59 should not have any protrusions with heights greater than the thickness of coating 57. If splined ends 37, 45 and coupling 49 are within the connection between seal section 29 and motor 31 (FIG. 1), motor lubricant within motor will immerse coating 57.

The present invention described herein, therefore, is well adapted to carry out the objects and attain the ends and advantages mentioned, as well as others inherent therein. While a few embodiments of the invention have been given for purposes of disclosure, numerous changes exist in the details of procedures for accomplishing the desired results. These and other similar modifications will readily suggest themselves to those skilled in the art, and are intended to be encompassed within the spirit of the present invention disclosed herein and the scope of the appended claims.

1. An apparatus for pumping well fluid from a well, comprising:
an electrical submersible pump assembly (“ESP”) having a longitudinal axis and a plurality of modules, including a pump, a seal section and a motor;
a rotatable first drive shaft in a first one of the modules, the first drive shaft being formed of a steel alloy;
a rotatable second drive shaft in a second one of the modules, the second drive shaft being formed of a steel alloy;
an external set of splines on end portions of the first drive shaft and the second drive shaft;
a coupling formed of a steel alloy and having an internal set of splines that mesh with the external set to rotationally couple the first and second drive shafts to each other; and
a coating selectively on either the internal set or on the external set, the coating being of a softer material than the materials of the internal set and the external set.

2. The apparatus according to claim 1, wherein the coating is a polymer.

3. The apparatus according to claim 1, wherein the coating is a polymer selected from the group consisting of polytetrafluoroethylene and polyimide.

4. The apparatus according to claim 1, wherein the coating has a thickness in the range from 0.002 to 0.014 inch.

5. The apparatus according to claim 1, wherein the coating is only on the internal set, and the external set is free of any coatings.

6. The apparatus according to claim 1, wherein the coating is a solid material.

7. The apparatus according to claim 1, wherein the coating has a lower coefficient of friction than the steel alloys of the first and second drive shafts and the coupling.

8. The apparatus according to claim 1, wherein the coating has a lower elastic modulus than the steel alloys of the first and second drive shafts and the coupling.

9. The apparatus according to claim 1, wherein:
the coating is bonded to the internal set and in contact with the steel alloy of the external set.

10. An apparatus for pumping well fluid from a well, comprising:
an electrical submersible pump assembly (“ESP”) having a longitudinal axis and a plurality of modules, including a pump, a seal section and a motor;
a rotatable first drive shaft in a first one of the modules, the first drive shaft being formed of a steel alloy;
a rotatable second drive shaft in a second one of the modules, the second drive shaft being formed of a steel alloy;
an external set of splines on mating ends of the first drive shaft and the second drive shaft;
a coupling formed of a steel alloy and having an internal set of splines that mesh with the external set to rotationally couple the first and second drive shafts to each other; and
a polymer coating selectively bonded on one of the sets and in sliding engagement with the steel alloy of the other set, the coating being a solid polymer material having a lower coefficient of friction than the steel alloys of the internal set and the external set.

11. The apparatus according to claim 10, wherein the coating is selected from the group consisting of polytetrafluoroethylene and polyimide.

12. The apparatus according to claim 10, wherein the coating has a thickness in the range from 0.002 to 0.014 inch.

13. The apparatus according to claim 10, wherein the coating is on the internal set.

14. The apparatus according to claim 10, wherein the coating is softer than the steel alloys of the first and second drive shafts and the coupling.

15. The apparatus according to claim 10, wherein the coating has a lower elastic modulus than the steel alloys of the first and second drive shafts and the coupling.

16. An apparatus for pumping well fluid from a well, comprising:
an electrical submersible pump assembly (“ESP”) having a longitudinal axis and a plurality of modules, including a pump, a seal section and a motor;
a rotatable first drive shaft in a first one of the modules, the first drive shaft being formed of a steel alloy;
a rotatable second drive shaft in a second one of the modules, the second drive shaft being formed of a steel alloy;
the first and second drive shafts having mating ends;
an external set of splines on the ends of the first drive shaft and the second drive shaft;
a coupling formed of a steel alloy and having an internal set of splines that mesh with the external set to rotationally couple the first and second drive shafts to each other;
a polymer coating selectively bonded on one of the sets and in sliding engagement with the steel alloy of the other set; and wherein
the coating is formed of polytetrafluoroethylene or polyimide, is softer than the steel alloys of the internal set and the external set, has a lower coefficient of friction than the steel alloys of the internal set and the external set, and has a lower elastic modulus than the steel alloys of the internal set and the external set.

17. The apparatus according to claim 16, wherein the coating has a thickness in the range from 0.002 to 0.014 inch.

18. The apparatus according to claim 16, wherein the coating is on the internal set.

19. The apparatus according to claim 16, wherein:
the splines of the internal set have internal set flanks;
the splines of the external set have external set flanks; and
the coating is bonded on the flanks of said one of the sets and in sliding engagement with the steel alloy of the flanks of the other set.

20. The apparatus according to claim 17, wherein:
the motor contains a motor lubricant;
the first drive shaft is located in the motor;
the second drive shaft is located in the seal section; and
the coating is immersed in the motor lubricant.
